(19) United States
(12) Patent Application Publication
(10) Pub. No.: US 2023/0050495 A1
(43) Pub. Date: Feb. 16, 2023

(54) Distributed and Synchronized Self-Charging Electric Car

(71) Applicant: Philip Gray, Bronx, NY (US)

(72) Inventor: Philip Gray, Bronx, NY (US)

(21) Appl. No.: 17/401,218

(22) Filed: Aug. 12, 2021

(51) Int. Cl. B60K 1/02; B60K 17/34; B60L 50/60; H02J 7/14

(52) U.S. Cl. CPC B60K 1/02; B60K 17/34; B60L 50/66; H02J 7/14

(57) ABSTRACT

The present invention is an electric vehicle wherein the vehicle is powered by an internal generator rather than the traditional method of plugging in to charge the electric battery. The internal generator is made up of an alternator and a regulator which control the flow of electricity to the battery of the car. The battery of the car will only need to be charged once at the beginning of use or first time use of the vehicle and then will obtain power from the internal generator.

### BACKGROUND

Electric cars were popular in the late 19th and early 20th century because they were low-maintenance, quiet, and clean. However, the mass production of gasoline using vehicles reduced the popularity of the electric vehicle. Many people now look to electric cars as a “green” or environmentally friendly transportation option. Many people see electric cars as better for the environment because they do not use limited fossil fuels or produce air pollution, exhaust.

The engine in an electric vehicle is powered by a rechargeable battery. The battery in an electric car needs to be recharged often. Electric car battery charging stations may be available at many locations such as apartment building and public parking garages, public streets, retail parking lots, new-car dealerships, and some retail locations. Charging is often free but may require a fee depending on the operator. This may be inconvenient for some electric car owners. If not sufficiently charged, the inability to function may cause the owner of the vehicle to be late to various events such as work or school. There have been no products available as original equipment or as an aftermarket to address this problem either.

There exists a need for a self-charging electric car that is not being met by any known or disclosed device or system of present.

### SUMMARY OF THE INVENTION

The present invention is an electric vehicle wherein the vehicle is powered by multiple internal generators rather than the traditional method of plugging in to charge the electric battery. The internal generators are made up of multiple alternators and multiple regulators which distribute, synchronize and control the flow of electricity to the battery of the car and power to the car drive train. The battery of the car will only need to be charged once at the beginning of use or first time use of the vehicle and then will obtain power from the internal generator.

The disclosed electric car drive train and charging system includes a first electric motor for a first drive train of the electric car and a second electric motor for a second drive train of the electric car. The disclosure also includes a first alternator for the first electric motor and a second alternator for the second electric motor. The disclosure additionally includes a first regulator for the first alternator and a second regulator for the second alternator. The disclosure further includes a first battery pack for the first electric motor and first alternator and a second battery pack for the second electric motor and second alternator. The disclosure yet includes a synchronizer for synchronizing a frequency, a phase and an amplitude of a first electrical system and of a second electrical system, wherein the first electrical system comprises the first electric motor, the first alternator, the first regulator and the first battery pack, and the second electrical system comprises the second electric motor, the second alternator, the second regulator and the second battery pack.

### BRIEF DESCRIPTION OF THE DRAWINGS

FIG. 1 is a depiction of the elements of the self-sustaining electric car in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term electric car is used to refer to a vehicle that uses electricity for power. An electric car does not use fuel like the majority of cars on the road today. The term self-charging refers to charging independent of an external power source.

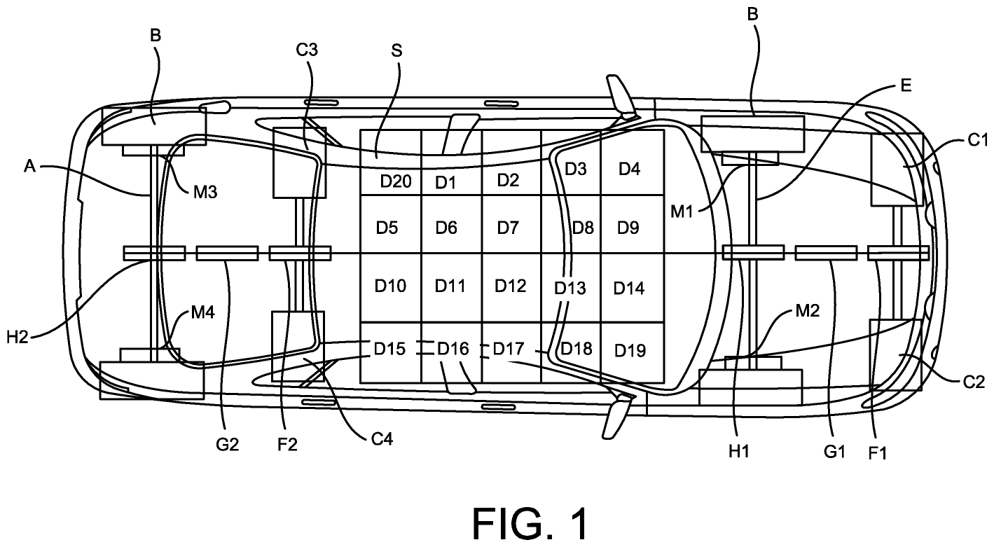

FIG. 1 is a depiction of the elements of the self-charging electric car in accordance with an embodiment of the present disclosure. The elements of the present invention include: rear axle A, tires B, alternator with regulator (gear control) C1, C2, C3 and C4, Batteries 1 through 20 D, front axle E, Gear 3 F1 and F2, Gear 2 G1 and G2, and Gear 1 H1 and H2. The motion of gears 1, 2, and 3 will generate power which is transferred to the motor to operate the vehicle. The respective alternator and regulator pairs C1 through C2 are synchronized by the synchronizer S in communication with each and every alternator, regulator, electric motors M1, M2, M3 and M4 and batteries D1:D19 and as many additional batteries as needed. Any combination of the alternators, regulators and electric motors are used including front to rear and left to right to achieve engineering goals and highest performance for 2 wheel, 4 wheel and extreme conditions as claimed herein.

The alternator works on the principle of electromagnetic induction, moving around its axis to produce electricity. The vehicle charges via the alternator while the car is running. Electric conversions are typically not one hundred percent, however, the present invention greatly increases the power range of the battery and makes the necessity for charging less frequent. The electricity derived from the charged battery will power the movement of the tires and axles (front and rear) of the vehicle. The present invention also contains gears that transmit power to the axles and wheels of the vehicle. The present invention improves the efficiency of electric cars and allows its users to be less dependent on external charging sources. The present invention may prove to be a necessity to all persons who seek to minimize the frequency of time necessary to charge an electric vehicle.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. An electric car drive train and charging system comprising:
a first electric motor for a first drive train of the electric car and a second electric motor for a second drive train of the electric car;
a first alternator for the first electric motor and a second alternator for the second electric motor;
a first regulator for the first alternator and a second regulator for the second alternator;
a first battery pack for the first electric motor and first alternator and a second battery pack for the second electric motor and second alternator; and
a synchronizer for synchronizing a frequency, a phase and an amplitude of a first electrical system and of a second electrical system, wherein
the first electrical system comprises the first electric motor, the first alternator, the first regulator and the first battery pack, and
the second electrical system comprises the second electric motor, the second alternator, the second regulator and the second battery pack.

2. The system of claim 1, wherein the first drive train is a front drive train and the second drive train is a rear drive train of the electric car.

3. The system of claim 1, wherein the first drive train is a front right wheel and the second drive train is a front left wheel of the electric car.

4. The system of claim 1, wherein the first drive train is a rear right wheel and the second drive train is a rear left wheel of the electric car.

5. The system of claim 1, wherein the first drive train is a front right wheel and the second drive train is a rear left wheel and a third drive train is a front left wheel and a fourth drive train is a rear right wheel of the electric car.

6. The system of claim 1, wherein the first drive train is a front right wheel and the second drive train is a rear right wheel and a third drive train is a front left wheel and a fourth drive train is a rear left wheel.

7. The system of claim 1, wherein each of the first battery pack and the second battery pack comprises a plurality of batteries connected in a parallel voltage configuration.

8. The system of claim 1, wherein the synchronizer synchronizes a third electrical system with the first and the second electrical systems and comprises a third electric motor, a third alternator, a third regulator and a third battery pack.

9. The system of claim 1, further comprising a third electrical system comprising a third electric motor, a third alternator, a third regulator and a third battery pack.

10. The system of claim 1, further comprising an Nth electrical system comprising an Nth electric motor, and Nth alternator, an Nth regulator and an Nth battery pack.

11. The system of claim 1, wherein the synchronizer synchronizes an Nth number of electrical systems each having a respective electric motor, an alternator, a regulator and a battery pack.

12. The system of claim 1, wherein the synchronizer synchronizes the frequency, phase and amplitude of first and second electrical systems via the respective alternator, regulator, battery pack and electric motor.
